(19) United States
(12) Patent Application Publication
(10) Pub. No.: US 2025/0231027 A1
(43) Pub. Date: Jul. 17, 2025

(54) SURVEY MARK

(71) Applicant: Georg Rothbucher, Bad Reichenhall (DE)

(72) Inventor: Georg Rothbucher, Bad Reichenhall (DE)

(21) Appl. No.: 19/028,349

(22) Filed: Jan. 17, 2025

(30) Foreign Application Priority Data
Jan. 17, 2024 (DE) 10 2024 101237.4

(51) Int. Cl. G01C 15/02; G01C 3/30

(52) U.S. Cl. CPC G01C 15/02; G01C 3/30

(57) ABSTRACT

A survey mark for surveying a reference point situated, for example, on an object to be surveyed comprises a reflector object which has a spherical surface. The spherical surface of the reflector object has a diameter in a range of between 10 and 50 mm, preferably in a range of between 20 and 40 mm. In another aspect, a method for surveying an object to be surveyed is disclosed. The reflector object comprises at least one aiming point marking which protrudes outwardly from the spherical surface and which has a longitudinal axis (L) that passes through a central point of the reflector object.

### CROSS-REFERENCE TO RELATED APPLICATIONS

This application claims the benefit of German Application No. 10 2024 101237.4, filed Jan. 17, 2024, which is incorporated by reference herein in its entirety.

### TECHNICAL FIELD

The disclosure relates to a survey mark for surveying a reference point and to a method of surveying an object to be surveyed.

### BACKGROUND

Survey marks are usually attached onto stationary objects such as buildings or electric poles placed along railway tracks. They may mark a reference point that is to be surveyed using commonly known measuring devices such as laser scanners, stereo cameras or total stations. The surveying procedures are generally based on electro-optical methods, such that survey marks will usually comprise complex optical elements such as triple mirrors. These survey marks are susceptible to getting damaged and they need to be regularly adjusted so as to enable them to be surveyed from different directions.

It is an object of the disclosure to specify a robust survey mark and a method of using a tachymeter for surveying a reference point in a quick and easy manner.

This object is solved by the subject matter of the independent claims. Advantageous developments are specified in the dependent claims and in the following description.

### BRIEF SUMMARY

A survey mark for surveying a reference point situated, for example, on an object to be surveyed comprises a reflector object which has a spherical surface. The spherical surface of the reflector object has a diameter in a range of between 10 and 50 mm, preferably in a range of between 20 and 40 mm. It is particularly preferred that the spherical surface has a diameter of 30 mm. The reflector object further comprises at least one aiming point marking which protrudes outwardly from the spherical surface. The aiming point marking has a longitudinal axis which extends through the center of the reflector object.

The spherical surface of the reflector object is in particular an outer surface of said reflector object. The spherical surface of the reflector object preferably points away from the center of the reflector object.

The spherical surface of the reflector object makes it possible to capture the survey mark in a simple manner from various different directions, particularly so without having to change the orientation of the survey mark or the reflector object. Furthermore, the characteristics of the survey mark enable a robust and compact design. In addition, the dimension of the reflector object makes it possible for the survey mark to be aimed at or sighted in a reliable and reproducible manner, in particular with the aid of a tachymeter or of a total station. For example, the reflector object allows the survey mark to be aimed at or sighted in a simple and precise manner by using a crosshair of the tachymeter. The aiming point marking that protrudes from the spherical surface allows the survey mark to be aimed at with particular accuracy. For example, the survey mark can be aimed at with the aid of the tachymeter or the total station by aligning a crosshair of a sight of the tachymeter or the total station with the aiming point marking. The longitudinal axis of the aiming point marking forms an auxiliary line that makes it easier for the survey mark to be aimed at. As the longitudinal axis of the aiming point marking passes through the center of the reflector object, the center of the reflector object can be aimed at particularly easily. With the help of an electro-optical range finder of the tachymeter, it is then possible to measure the distance between the tachymeter and the survey mark, in particular the reflector object. The survey mark can be aimed at and surveyed using a tachymeter, for example up to a maximum distance of 200 m, 150 m, 100 m, or 50 m. This is possible, in particular, with a degree of precision in a range of between 1 and 2 mm. The survey mark is specifically a survey mark for surveying a reference point with the aid of a tachymeter.

The aiming point marking is, for example, a cylindrical or rod-shaped raised portion protruding from the spherical surface. An aiming point marking of this type has a naturally marked out longitudinal axis with which a crosshair may be aligned particularly easily. However, the aiming point marking can also be an elongated protrusion having any other cross-section, for example an oval cross-section, a triangular, quadrangular or other polygonal cross-section. In many aiming point markings, these are preferably uniformly arranged on the spherical surface. In addition, a further aiming point marking can be arranged on the spherical surface along a plane that intersects the axis of rotation of the spherical surface.

In one embodiment, the reflector object comprises at least two aiming point markings arranged at two opposite points along the spherical surface. In such an embodiment, the center of the reflector object lies between the two aiming point markings. The two aiming point markings thus form an easily recognizable auxiliary line that enables the center of the reflector object to be aimed at in a reliable manner. This enables a particularly high level of measuring accuracy to be achieved when using the survey mark.

In one embodiment, the survey mark comprises a mount, with the reflector object being connected to the mount. The mount makes it easy to attach the survey mark to an object to be surveyed such as a wall. Preferably, the reflector object is connected to the mount at two points located opposite each other along the spherical surface. The reflector object can be arranged at a given distance from the mount, for example by using a cylindrical object.

In one embodiment, the reflector object is connected to the mount via at least one of the aiming point markings. The aiming point marking thus ensures that the reflector object is positioned at a given distance from the mount, which makes it even easier for the reflector object to be aimed at.

In one embodiment, the reflector object is connected to the mount at two points located opposite each other along the spherical surface via at least two of said aiming point markings. This ensures that the reflector object is held in place in a particularly reliable manner. Furthermore, the two aiming point markings serve for forming said easily recognizable auxiliary line that enables the center of the reflector object to be aimed at in a reliable manner.

In one embodiment, the reflector object has a spherical element and a shell element arranged around said spherical element, wherein the shell element encompasses the spherical surface and a reflecting foil is arranged between the spherical element and the shell element. This enables a particularly reliable distance determination with the aid of an electro-optical range finder of a tachymeter. The spherical surface is, for example, an outer surface of the shell element and the foil is arranged on an inner surface of the shell element. The foil is notably spherical, corresponding to the spherical surface of the reflector object. The reflecting foil may be a metal foil or a reflex foil, for example. The reflex foil preferably comprises retroreflective elements.

In one embodiment, the reflector object is made of a plastic material, in particular a light-colored plastic material. This enables a simple and robust design of the survey mark. The light color of the reflector object makes the reflector object easy to aim at using a tachymeter. For example, the reflector object can be made of white or gray plastic material. It may further be specified that the reflector object is not made of black plastic material. For example, the spherical element and the shell element can be made of plastic material.

In one embodiment, the reflector object is made of a metal, in particular of aluminum or steel. This enables a simple and robust design of the survey mark.

In one embodiment, at least the spherical surface is fluorescent. This enables the survey mark to be aimed at regardless of the ambient light conditions. For example, the spherical surface can comprise a fluorescent color. As a further example, the spherical surface can be made of a fluorescent plastic material.

In another aspect, a method for surveying an object to be surveyed with the aid of the above-described survey mark is provided. Said method includes the steps of: aiming at at least one survey mark arranged on the object to be surveyed with the aid of a tachymeter in which a crosshair of the tachymeter is aligned with at least one of the aiming point markings; determining at least one measurement, in particular with the aid of the tachymeter, with respect to the at least one survey mark that is being aimed at. For example, it is possible for the survey mark, in particular a reflector object of the survey mark, to be aimed at with the aid of the tachymeter, which may, in particular, be a total station. Subsequently, an electro-optical range finder, such as a laser range finder, of the tachymeter, may be used, for example, to determine the distance of the survey mark.

When the survey mark is being aimed at, the crosshair of the tachymeter is centered on the survey mark, in particular on the reflector object of the survey mark. Thus, what is being aimed at is in particular the center of the survey mark, or, more precisely speaking, the center of the reflector object of the survey mark. The longitudinal axis of the aiming point marking will thus form an auxiliary line that makes it easier for the center of the reflector object to be aimed at. Thus, the crosshair of the tachymeter can be aligned with the aiming point marking by aligning the crosshair with this auxiliary line. The center of the reflector object of the survey mark may serve as the reference point. Alternatively, the survey mark can be arranged on a reference point to be measured in such a way that the center of the reflector object is positioned at a defined distance from this reference point.

In one embodiment, the method comprises the step of: providing additional measurement information on the at least one survey mark that is being aimed at. Such additional measurement information on the survey mark can, for example, include dimensions of the survey mark, in particular dimensions of the reflector object. In particular, the measurement information comprises at least one radius of the spherical surface of the reflector object. The measurement information of the survey mark can also include a material property of the survey mark, in particular a material property of the reflector object. Providing the measurement information makes it possible to take into account properties of the survey mark, particularly in the step of determining at least one measurement. This enables precise surveying of the object to be surveyed. Said additional measurement information may specifically be determined and/or provided prior to the step in which the survey mark is being aimed at.

For example, the distance between the tachymeter and the survey mark may be determined on the basis of the transit time or running length of a measuring beam. For example, when the radius of the spherical surface of the reflector object is taken into account, the distance between the tachymeter and the center of the reflector object of the survey mark that is being aimed at can be determined with particular accuracy by using the transit time or running length of the measuring beam. Due to the spherical surface of the reflector object, it is possible to determine the distance to the center of the reflector object from a variety of different directions. For example, when using the tachymeter to determine the distance to the center of the reflector object, said distance may at least be determined from a first position of the tachymeter and then be determined from a second position of the tachymeter, in particular without any need for the reflector object to be adjusted or realigned. This enables very precise surveying of the object to be surveyed, in particular from various different directions.

Such additional measurement information can further comprise general information that may have an influence on electro-optical range finding operations carried out with the aid of a tachymeter For example, when range finding is performed using a laser, the penetration depth of the laser beam into the material of the reflector object can be taken into account as a measurement-relevant material property of the reflector object. It has been recognized that the absorption behavior of different materials, in particular different plastic materials, can cause a measurement error in the transit time or running length of the measuring beam. When using a reflector object made of plastic material, for example, the measured running length of the measuring beam can change by several millimeters compared to the use of a reflector object made of metal. The change in the running length may further depend on the color of the material used for the reflector object. When determining the at least one measurement, such a measurement error may, in particular, be taken into account as being caused by the material property of the reflector object, in order to significantly increase the accuracy of the measurement. Providing such additional measurement information thus adds particular precision to the surveying of the object to be surveyed.

Such additional measurement information makes it possible to determine at least one measurement with particular accuracy by a very simple procedure and thus to greatly enhance the surveying quality of the object to be surveyed.

The method can be further developed using the characteristics of the survey mark.

### BRIEF DESCRIPTION OF THE DRAWINGS

Further characteristics and advantages may be seen in the following description, in which exemplary embodiments will be explained in greater detail in connection with the attached Figures.

In the drawings:

FIG. 1 is a schematic view of a first survey mark,

FIG. 2 is a schematic view of a second survey mark,

FIG. 3 is a schematic view of a third survey mark,

FIG. 4 is a schematic view of a fourth survey mark,

FIG. 5 is a schematic representation of the view through a target acquisition optics or a sight of the tachymeter and onto the fourth survey mark.

### DETAILED DESCRIPTION

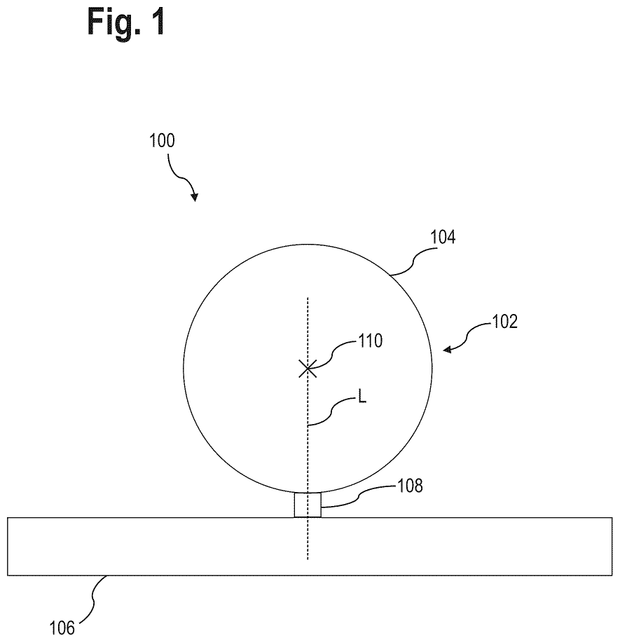

FIG. 1 is a schematic view of a survey mark 100. The survey mark 100 comprises reflector object 102 having a spherical surface 104. The survey mark 100 further comprises a mount 106. Merely by way of example, the reflector object 102 is connected to the mount 106 via an aiming point marking 108.

With the aid of the mount 106, the survey mark 100 can be disposed on an object to be surveyed. The mount 106 may be used, in particular, to affix the survey mark 100 in a defined position relative to a reference point on the object to be surveyed. For this purpose, the mount 106 may comprise a retainer for accommodating a fastening system and/or may comprise an alignment marker for aligning and fastening the mount 106 or the survey mark 100 in the defined position relative to the reference point on the object to be surveyed.

The spherical surface 104 of the reflector object 102 has a diameter in a range of between 10 and 50 mm, preferably in a range of between 20 and 40 mm. The dimension of the reflector object 102 makes it possible for the reflector object 102, and thus for the survey mark 100, to be reliably aimed at, for example with the aid of a tachymeter. For this purpose, the reflector object 102 can be aimed at using, for example, target acquisition optics of the tachymeter. The absence of complex optical elements, such as triple mirrors, enables a robust and simple design of the survey mark.

The spherical shape of the surface 104 makes it possible for the reflector object 102, and thus for the survey mark 100, to be reliably aimed at from a variety of directions without any need for realigning the reflector object 102 each time with the respective direction.

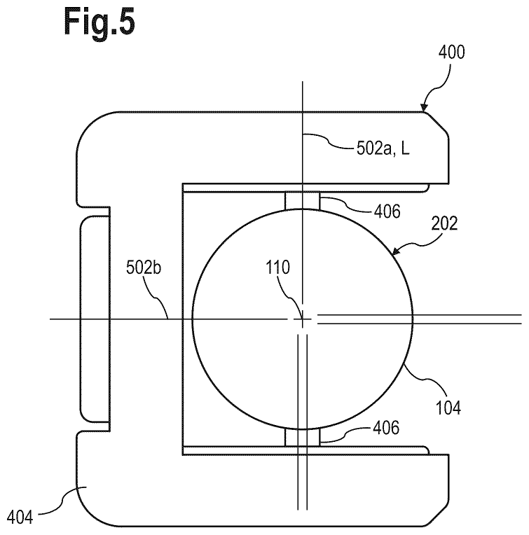

The aiming point marking 108 is formed, merely by way of example, as a cylindrical or rod-shaped raised portion protruding from the spherical surface 104 and, in this embodiment example, connects the reflector object 102 to the mount 106. The cylindrical shape of the aiming point marking 108 defines a longitudinal axis L that passes through a center point 110 of the reflector object 102. For example, a crosshair 500 of a tachymeter (see FIG. 5) can be aligned with this longitudinal axis in order to use the tachymeter for aiming at the center 110 of the reflector object 102. The alignment of the crosshair 500 is described below in greater detail with reference to FIG. 5.

The reflector object 102 is spaced apart from the mount 106 by the aiming point marking 108. In particular, the reflector object 102 is spaced apart from the mount 106 in a direction perpendicular to the plane of the aiming point marking 108. Furthermore, the longitudinal axis L of the aiming point marking 108 may be perpendicular to the plane of the aiming point marking 108.

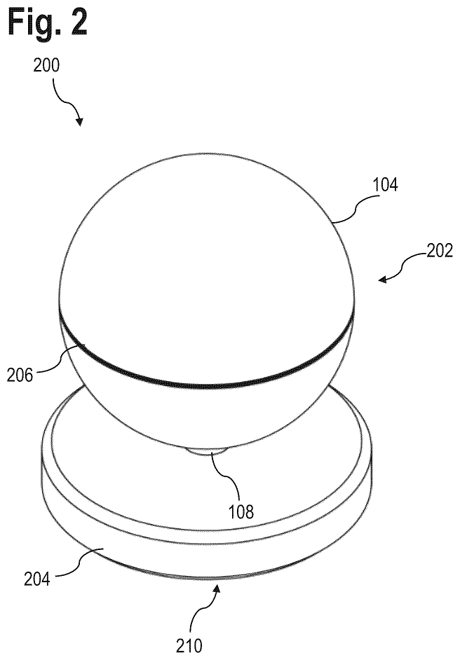

FIG. 2 is a schematic view of a survey mark 200. The survey mark 200 comprises a reflector object 202 having a spherical surface 104. The survey mark 200 further comprises a mount 204. The reflector object 202 is connected to the mount 204.

The reflector object 202 has a further aiming point marking 206 that runs around the circumference of the spherical surface. The aiming point marking 206 lies in a plane that intersects the axis of rotation of the spherical surface 104. In particular in conjunction with the aiming point marking 108, the aiming point marking 206 enables the reflector object 202 to be aimed at in a simple manner with the aid of the tachymeter. In this manner, it is notably possible for the center or central point 110 of the reflector object 202 to be reliably aimed at.

The mount 204 may preferably have a support surface 210 facing away from the reflector object 202, which is parallel to the plane of the aiming point marking 206. The base can, for example, be applied on an object to be surveyed and on which the survey mark 200 is arranged. This makes it possible to precisely align the aiming point marking 206 with the object to be surveyed.

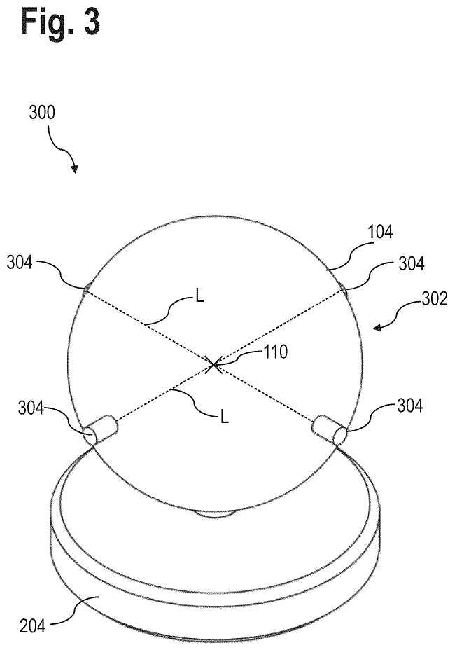

FIG. 3 is a schematic view of a survey mark 300. The survey mark 300 comprises a reflector object 302 having a spherical surface 104. The survey mark 300 further comprises the mount 204 to which the reflector object 302 is connected.

The reflector object 302 further comprises aiming point markings 304. Merely by way of example, the aiming point markings 304 are cylindrical elements that protrude outwardly from the spherical surface 104. Alternatively, the aiming point markings 304 may be recessed from the spherical surface 104. The four aiming point markings 304 are arranged two by two at two respectively opposite points along the spherical surface 104. The longitudinal axes L of the opposite aiming point markings 304 run through the center 110 of the reflector object 302. These auxiliary lines enable the survey mark 300, notably the center 110 of the reflector object 302, to be aimed at with particular reliability, which center may correspond to the reference point or may be arranged in a defined position relative to the reference point of the object to be surveyed. The aiming point markings 304 enable the reflector object 302 to be aimed at in a simple manner with a tachymeter. In particular, the center or central point 110 of the reflector object 302 can be reliably aimed at in this manner.

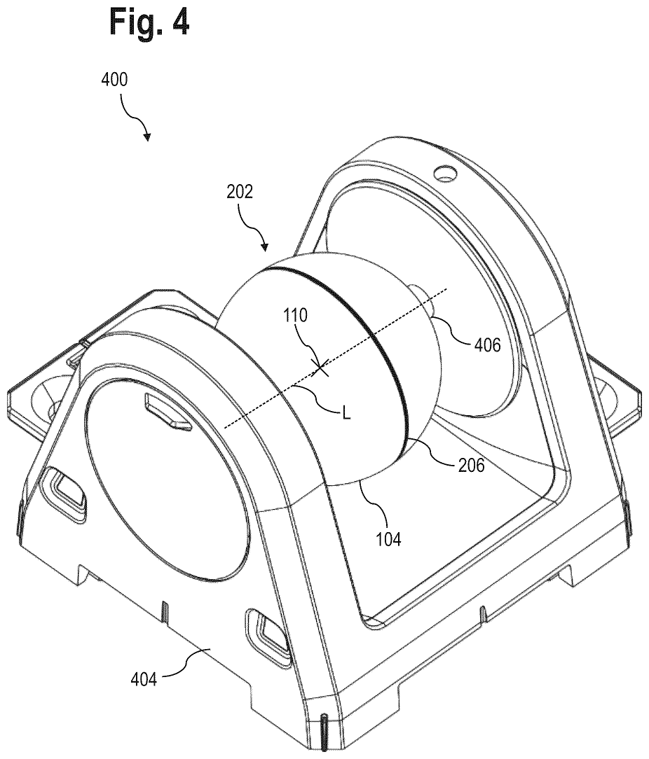

FIG. 4 is a schematic view of a survey mark 400. The survey mark 400 comprises the reflector object 202 having the spherical surface 104. The survey mark 400 further comprises a mount 404 to which the reflector object 202 is connected.

The reflector object 202 is connected to the mount 404 at two points located opposite each other along the spherical surface 104. The connection is realized by two aiming point markings 406, which are formed, purely by way of example, as cylindrical raised portions protruding from the spherical surface 104. The cylinder axes of the aiming point marking 406 each define a longitudinal axis L that passes through a center point 110 of the reflector object 202. The crosshair 500 of the tachymeter can be aligned using this imaginary auxiliary line in order to aim at the center 110 of the reflector object 202.

The survey mark 100, 200, 300, 400 can be used in particular in a method for surveying an object to be surveyed. At least one survey mark 100, 200, 300, 400 arranged on the object to be surveyed is aimed at with the aid of the tachymeter. For this purpose, the respective reflector object 102, 202, 302 can be aimed at using, for example, target acquisition optics or a sight of the tachymeter. In particular, a center of the reflector object 102, 202, 302, for example the center 110 of the reflector object 202, is being aimed at. The dimensions of the reflector objects 102, 202, 302 and the aiming point markings 108, 206, 304, 406 enable the reflector objects 102, 202, 302 to be aimed at in a simple and reproducible manner with the aid of the target acquisition optics of the tachymeter.

Furthermore, the method serves for determining, with the aid of the tachymeter, a measurement in relation to the at least one survey mark 100, 200, 300, 400, in particular to the respective reflector object 102, 202, 302 that is being aimed at. This may, in particular, be used to determine a distance to the survey mark 100, 200, 300, 400 that is being aimed at.

Preferably, the method provides additional measurement information on the survey mark 100, 200, 300, 400. The provided additional measurement information can then be taken into account when determining the measurement. For example, the radius of the spherical surface 104 or a material property of the spherical surface 104 can be taken into account when determining the measurement. Thus, the central point 110 or the center of the reflector object 102, 202, 302 can be determined while taking into account such additional measurement information. Furthermore, the spherical shape of the surface 104, while taking into account its radius, makes it possible for the central point 110 of the reflector object 102, 202, 302 to be determined from a plurality of directions. This will not require any realignment or adjustment of the reflector object 102, 202, 302.

FIG. 5 is a schematic representation of the view through a target acquisition optics or a sight of the tachymeter. Merely by way of example, the survey mark 400 described above with reference to FIG. 4 is being aimed at using the tachymeter.

The crosshair 500 is centered onto the central point 110 of the reflector object 202. This is achieved by aligning a vertical line 502a of the crosshair 500 with the longitudinal axis L of the two aiming point markings 406. In FIG. 5, the vertical line 502a of the crosshair 500 covers the longitudinal axis L. A horizontal line 502b of the crosshair 500 is oriented such that said horizontal line 502b covers an imaginary line on the spherical surface 104 where the spherical surface 104 is at its greatest extent in the horizontal direction. In other words: in FIG. 5, the horizontal line 502b covers the horizontally arranged great circle of the spherical surface 104.

1. A survey mark for surveying a reference point, the survey mark comprising:
a reflector object that has a spherical surface,
wherein the spherical surface of the reflector object has a diameter in a range of between 10 and 50 mm, preferably in a range of between 20 and 40 mm, and
wherein the reflector object comprises at least one aiming point marking which protrudes outwardly from the spherical surface and which has a longitudinal axis that passes through a central point of the reflector object.

2. The survey mark as claimed in claim 1, wherein the reflector object comprises at least two aiming point markings that are arranged at two opposite points along the spherical surface.

3. The survey mark as claimed in claim 1, comprising a mount, wherein the reflector object is connected to the mount via an aiming point marking of the at least one aiming point marking.

4. The survey mark as claimed in claim 3, wherein the reflector object is connected to the mount via at least two of the aiming point markings arranged at two opposite points along the spherical surface.

5. The survey mark as claimed in claim 1, wherein the reflector object comprises a spherical element and a shell element arranged around said spherical element, wherein the shell element encompasses the spherical surface, and a reflecting foil is arranged between the spherical element and the shell element.

6. The survey mark as claimed in claim 1, wherein the reflector object is made of a plastic material.

7. The survey mark as claimed in claim 1, wherein the reflector object is made of a metal.

8. The survey mark as claimed in claim 1, wherein at least the spherical surface is fluorescent.

9. A method for surveying an object to be surveyed including the survey mark as claimed in claim 1, said method comprising the steps of:
aiming at the survey mark arranged on the object to be surveyed with the aid of a tachymeter in which a crosshair of the tachymeter is aligned with an aiming point marking of the at least one aiming point marking; and
determining at least one measurement with respect to the survey mark that is being aimed at.

10. The method as claimed in claim 9, wherein said method comprises:
providing at least one additional measurement information item on the at least one survey mark that is being aimed at from the following list: dimensions of the survey mark, and a material property of the survey mark; and
determining the at least one measurement, said measurement being based on said at least one additional measurement information item.

11. The method as claim in claim 10, wherein the dimensions of the survey mark comprise dimensions of the reflector object.

12. The method as claimed in claim 11, wherein the material property of the survey mark comprises a material property of the reflector object.
